(19) United States
(12) Patent Application Publication
(10) Pub. No.: US 2017/0009989 A1
(43) Pub. Date: Jan. 12, 2017

(54) GAS TURBINE COMBUSTION CHAMBER WITH INTEGRATED TURBINE INLET GUIDE VANE RING AS WELL AS METHOD FOR MANUFACTURING THE SAME

(71) Applicant: Rolls-Royce Deutschland Ltd & Co KG, Blankenfelde-Mahlow (DE)

(72) Inventor: Carsten CLEMEN, Mittenwalde (DE)

(21) Appl. No.: 15/202,102

(22) Filed: Jul. 5, 2016

(30) Foreign Application Priority Data
Jul. 6, 2015 (DE) 10 2015 212 573.4

(51) Int. Cl. F23R 3/00; B23P 15/00

(52) U.S. Cl. CPC F23R 3/002; B23P 15/00; F05D 2220/32; F05D 2230/31; F05D 2240/35; F05D 2230/54

(57) ABSTRACT

A gas turbine combustion chamber with an outer combustion chamber wall and an inner combustion chamber wall, wherein the outer combustion chamber wall and the inner combustion chamber wall are respectively formed in one piece with an outer or an inner ring-shaped platform that are connected in one piece with turbine inlet guide vanes which are arranged around the circumference, wherein the gas turbine combustion chamber is mounted only by means of a suspension device that is formed in one piece at the outer platform, as well as a method for manufacturing the same.

The invention relates to a gas turbine combustion chamber according to the features of the generic term of claim 1.

In particular, the invention relates to a gas turbine combustion chamber with an outer combustion chamber wall and an inner combustion chamber wall, wherein the outer combustion chamber wall and the inner combustion chamber wall are respectively formed in one piece with an outer or inner ring-shaped platform, wherein the platforms are connected in one piece with turbine inlet guide vanes that are arranged around the circumference, forming a turbine inlet guide vane ring.

In the designs of annular combustion chambers for gas turbines as they are known in the state of the art, the combustion chamber and the turbine inlet guide vane ring are usually embodied in the form of two constructionally independent components. At that, various manufacturing methods are used, and also different materials may be applied.

There are two constructions shown in the state of the art in which the gas turbine combustion chamber has an outer and an inner combustion chamber wall that are made of sheet metal material and are respectively separately suspended or mounted by means of flanges. These flanges are usually embodied as forged parts and are connected to the combustion chamber walls. This results in considerable production costs, which also leads to additional weight.

Known combustion chambers are either formed with a single wall or have an additional protective structure that is oriented towards the interior of the combustion chamber and provides a shielding function against the heat of the combustion gases. This construction may for example comprise combustion chamber shingles that are screwed to the outer or inner combustion chamber wall by means of bolts. Further, the combustion chamber walls and the shingles additionally have air mixing holes so as to control the combustion. In addition, cooling holes are provided for cooling the combustion chamber walls as well as the shingles. This, too, results in a high production-technological effort, which also leads to additional weight.

Usually, a turbine inlet guide vane ring is arranged downstream of the gas turbine combustion chamber. It is manufactured as a separate structural component and connected via an interface to the gas turbine combustion chamber. This interface may for example comprises a seal from the combustion chamber to the turbine inlet guide vane ring. The turbine guide vane is mounted independently of the combustion chamber, so that there is the need to take measures for sealing any leakages between the combustion chamber and the turbine inlet guide vane. The leakages result, among other things, from the floating mounting of the combustion chamber and the turbine inlet guide vane ring in relation to each other, through which very large axial and radial movements may result. This leads to a reduction in the the degree of efficiency, resulting in increased fuel consumption.

From U.S. Pat. No. 7,249,462 B2 a gas turbine combustion chamber is known, in which a turbine inlet guide vane ring that is provided with stator blades is formed in one piece at the discharge area of the gas turbine combustion chamber. This overall construction is mounted outside and inside at the front area of the gas turbine combustion chamber (in relation to the through-flow direction) as well as at the transitional area to the high-pressure turbine. This results in a very elaborate construction that entails very high manufacturing costs and that is loaded with additional weight.

WO 2014/099074 A2 and WO 2014/099076 A2 respectively show one construction in which the gas turbine combustion chamber is also connected in one piece with a turbine inlet guide vane ring. Here, too, an elaborate suspension is provided radially outside as well as radially inside, with respect to the engine central axis. EP 1 775 561 A2 and FR 2 992 018 A1 show a similar construction.

The invention is based on the objective to create a gas turbine combustion chamber of the kind as it has been mentioned in the beginning, which is characterized by a simple construction, easy manufacturability, low costs and a high degree of functionality while at the same time avoiding the disadvantages of the state of the art.

According to the invention, this objective is solved by a combination of features of claim 1, with other advantageous embodiments of the invention being shown in the subclaims.

Thus, it is provided according to the invention that the gas turbine combustion chamber has an outer combustion chamber wall and an inner combustion chamber wall. Combined, they result is an annular combustion chamber, with a combustion chamber head being arranged at the inflow area. The outer combustion chamber wall and the inner combustion chamber wall are respectively formed in one piece with an outer ring-shaped or partially ring-shaped platform, or an inner ring-shaped or partially ring-shaped platform. Between the outer and the inner platform, turbine inlet guide vanes are arranged that are formed in one piece with the platforms and are evenly distributed around the circumference so as to form a turbine inlet guide vane ring.

In the one-piece design according to the invention, it is necessary that the combustion chamber head, which can be embodied according to the constructions of the state of the art, is connected to the combustion chamber walls in a detachable manner in order to facilitate accessibility into the combustion chamber. This accessibility is necessary for exchanging heat shields or the like, for example.

It is provided according to the invention that the gas turbine combustion chamber is mounted exclusively by means of a suspension device that is formed at the outer platform of the turbine inlet guide vane ring. This suspension device can for example be embodied in the form of a ring flange that is formed in one piece with the outer platform or in the form of individual struts.

Thus, according to the invention, this results in a one-piece construction. When it comes to the manufacturing process, it is manufactured according to the invention by means of an additive method as one-piece. According to the invention, the one-piece product can be designed in such a manner that the gas turbine combustion chamber is formed as a full ring. However, it is also possible to manufacture individual segments by means of a one-piece production method, subsequently joining them together so that they form a full ring, which can be done by means of welding or screwing, for example.

According to the invention, it is possible to form the outer combustion chamber wall and the inner combustion chamber wall with a single wall. But it is also possible to respectively form them with double walls and to provide them with heat shields and shingles, for example for the purpose of heat shielding. In the embodiment of the combustion chamber wall according to the invention and the method according to the invention which it is based on, these shingles are also manufactured in one piece together with the combustion chamber wall by using an additive method.

The construction according to the invention leads to a considerable weight reduction, as there are no suspensions provided at the combustion chamber itself, but the entire gas turbine combustion chamber is mounted together with the turbine inlet guide vane ring exclusively by means of the outer platform of the turbine inlet guide vane ring. According to the invention, seals or the like between the combustion chamber and a separately manufactured turbine inlet guide vane ring can also be dispensed with. In this way, in addition to the lower manufacturing costs and the lower weight, the leakages occurring between the combustion chamber and the turbine inlet guide vane ring are also reduced. This results in lower NOx emissions as well as lower fuel consumption.

In addition, the additive manufacture of the gas turbine combustion chamber according to the invention results in an optimal arrangement and design of all cooling air holes, which also includes the cooling of the outer and inner platform of the turbine inlet guide vane ring. This, too, leads to an increased efficiency of the as turbine combustion chamber.

The manufacture of the entire as turbine combustion chamber including the turbine inlet guide vane ring as it is provided according to the invention results in advantages in the additive design, since only one structural component remains to be manufactured by means of a technology. The gas turbine combustion chamber according to the invention can for example be manufactured from CM247, CM247LC, MarM002 or Hastelloy X. Here, the additive method can be a DLD method (direct laser depositioning) or a DMLS method (direct metal laser sintering).

In the following, the invention is described in connection to the drawing by referring to an exemplary embodiment. Herein:

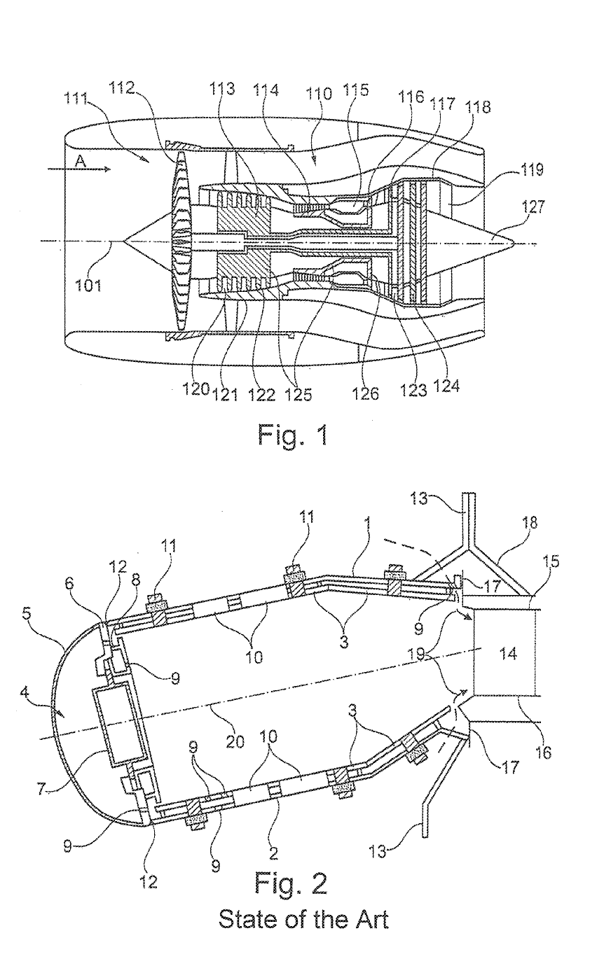

FIG. 1 shows a gas turbine engine for use of the gas turbine combustion chamber according to the invention,

FIG. 2 shows a simplified side view of a combustion chamber according to the invention according to the state of the art,

FIG. 3 shows a view, analogous to FIG. 2, of an exemplary embodiment of a gas turbine combustion chamber according to the invention,

FIG. 4 shows a view, analogous to FIG. 3, of another exemplary embodiment in a single-wall design, and

FIGS. 5, 6 show simplified views of segments of the gas turbine combustion chamber according to the invention in other exemplary embodiments.

The gas turbine engine 110 according to FIG. 1 represents a general example of a turbomachine in which the invention can be used. The engine 110 is embodied in the conventional manner and comprises, arranged in succession in the flow direction, an air inlet 111, a fan 112 that is circulating inside a housing, a medium-pressure compressor 113, a high-pressure compressor 114, a combustion chamber 115, a high-pressure turbine 116, a medium-pressure turbine 117 and a low-pressure turbine 118, as well as an exhaust nozzle 119, which are all arranged around a central engine axis 101.

The medium-pressure compressor 113 and the high-pressure compressor 114 comprise multiple stages, respectively, with each of these stages having an array of fixedly attached stationary guide blades 120 extending in the circumferential direction, which are generally referred to as stator blades and which protrude radially inwards from the core engine housing 121 through the compressors 113, 114 into a ring-shaped flow channel. Further, the compressors have an array of compressor rotor blades 122 that protrude radially outwards from a rotatable drum or disc 125, [and] which are coupled to hubs 126 of the high-pressure turbine 116 or of the medium-pressure turbine 117.

The turbine sections 116, 117, 118 have similar stages, comprising an array of fixedly attached guide blades 123 which are protruding through the turbines 116, 117, 118 in a radially inward direction from the housing 121 into the ring-shaped flow channel, and a subsequent array of turbine blades 124 that are protruding externally from a rotatable hub 126. In operation, the compressor drum or compressor disc 125 and the blades 122 arranged thereon as well as the turbine rotor hub 126 and the turbine rotor blades 124 arranged thereon rotate around the engine axis 101.

FIG. 2 shows the structure of a gas turbine combustion chamber according to the state of the art. The gas turbine combustion chamber comprises an outer combustion chamber wall 1 as well as inner combustion chamber wall 2, which are respectively formed with double walls and comprise combustion chamber shingles 3 or a second, parallel combustion chamber wall at that side which is facing towards the combustion space. At the inflow area, a combustion chamber head 4 is arranged, comprising a combustion chamber head cup 5 as well as a head plate 6. Centrically, respectively one burner seal 7 is arranged that is provided with a meshing hole for a fuel nozzle. Further, the combustion chamber head 4 comprises a heat shield 8 that is provided with cooling air holes 9. The combustion chamber head 4 is fixedly connected to the outer combustion chamber wall 1 or the inner combustion chamber wall 2 by means of weld seams 12.

The outer and the inner combustion chamber wall 1, 2 are provided with mixing holes 10 for the supply of mixed air, as well as with cooling air holes 9. The attachment of the combustion chamber shingles 3 is effected by means of bolts 11, as it is known from the state of the art.

The known gas turbine combustion chamber is mounted by means of an outer and an inner combustion chamber suspension 13.

At the outflow area of the gas turbine combustion chamber, turbine inlet guide vanes 14 of a turbine inlet guide vane ring are arranged. The turbine inlet guide vanes 14 are respectively connected with an outer platform 15 and an inner platform 16, and are mounted by means of a suspension device 18. Between the turbine inlet guide vane ring with the turbine inlet guide vanes 14, a seal 17 is provided in order to ensure sealing between the combustion chamber and the turbine inlet guide vane ring. Further, an inlet guide vane platform cooling 19 is provided in this area in order to supply additional cooling air. The interface between the combustion chamber and the turbine inlet guide vane ring also requires increased cooling, since the options for effectively cooling the inlet guide vane platforms are considerably restricted. This additional cooling air is no longer available for the admixture into the combustion chamber through the mixing holes 10 and has a negative effect on NOx emissions.

All in all, the described construction of the state of the art results in a high manufacturing effort, which is also due to the high number of parts being used. This leads to a considerable total weight. Further, the sealing between the combustion chamber and the turbine inlet guide vane ring is critical and requires additional measures.

FIGS. 3 and 4 show a first and a second exemplary embodiment of the invention.

In the first exemplary embodiment of FIG. 3, a gas turbine combustion chamber in a construction is shown that is analogous to the state of the art which is described in connection with FIG. 2. Like parts are identified by the like reference signs, so that a repeated description can be omitted.

In the exemplary embodiment shown in FIG. 3, the outer combustion chamber wall 1 is formed in one piece with a ring-shaped outer platform 15, while the inner combustion chamber wall 2 is formed in one piece with the inner platform 16. The terms “outer” and “inner” respectively refer to engine central axis 101, see FIG. 1. Turbine inlet guide vanes 14 are formed in one piece with the outer platform 15 and the inner platform 16 and are distributed evenly around the circumference of the gas turbine combustion chamber.

It is provided according to the invention that the suspension of the entire combustion chamber together with the turbine inlet guide vane ring which is formed by the turbine inlet guide vanes 14 and the platforms 15 and 16 is effected exclusively by means of a single suspension device 18 at the radially outer side. Thus, the combustion chamber according to the invention itself is not additionally mounted. This leads to a considerable reduction of the required structural components and to a drastic reduction of the total weight. Further, the additive manufacture as it is provided according to the invention makes it possible for the cooling air holes 9 and the mixing holes 10 to be manufactured in one piece with the combustion chamber shingles 3 and to be optimized with respect to their geometry and the arrangement.

In the design according to the invention, it is not necessary to provide additional measures for ensuring sealing between the combustion chamber and the turbine inlet guide vane ring.

According to the invention, the combustion chamber head 4 is screwed or connected in another detachable manner to the outer combustion chamber wall 1 and to the inner combustion chamber wall 2 in order to facilitate access to the interior of the combustion chamber.

FIG. 4 shows an exemplary embodiment in analogous design to the exemplary embodiment of FIG. 3, so that a repeated description of the structural components can be omitted. The exemplary embodiment of FIG. 4 is formed with one wall and thus comprises only one outer combustion chamber wall 1 as well as an inner combustion chamber wall 2, which are respectively connected in one piece with the outer platform 15 and the inner platform 16. Also in this embodiment, the entire suspension and mounting of the total arrangement of gas turbine combustion chamber and turbine inlet guide vane ring is effected exclusively by means of the suspension arrangement 8 that is arranged radially outside and is connected in one piece with the outer platform 15.

FIGS. 3 and 4 respectively show two bolts 11, by means of which the combustion chamber head 4 is attached in a detachable manner. The reference sign 20 refers to the combustion chamber central axis.

According to the invention, it is possible to form the gas turbine combustion chamber in one piece as a ring together with the turbine inlet guide vane ring. Thanks to the additive manufacturing method that is provided according to the invention and that may be a DLD or a DLMS method, such a one-piece design and manufacture is facilitated. As an alternative to this, it is also possible to form the gas turbine combustion chamber according to the invention together with the turbine inlet guide vane ring in the form of segments. Examples of such segments are shown in FIGS. 5 and 6. The segments may for example extend across a circumferential angle of 45 degrees with respect to the combustion chamber central axis 20. The exemplary embodiments differ with respect to the number of turbine inlet guide vanes 14. As for their number, it is always an integral multiple of the number of fuel nozzles, the position of which is determined based on the meshing surface of the burner seals 7. The individual segments that are shown in FIG. 5 or 6 can be welded or screwed together according to the invention in order to form a full ring and thus the entire gas turbine combustion chamber. The number of the segments can be chosen freely, for example each segment may comprise one fuel nozzle or two fuel nozzles.

### PARTS LIST

1 outer combustion chamber wall
2 inner combustion chamber wall
3 combustion chamber shingle
4 combustion chamber head
5 combustion chamber head cup
6 head plate
7 burner seal with meshing hole of a fuel nozzle
8 heat shield
9 cooling air hole
10 mixing hole
11 bolt
12 weld seam
13 combustion chamber suspension
14 turbine inlet guide vane
15 outer platform
16 inner platform
17 seal between combustion chamber and turbine inlet guide vane ring
18 suspension device
19 platform cooling
101 engine central axis
110 gas turbine engine/core engine
111 air inlet
112 fan
113 medium-pressure compressor (compactor)
114 high-pressure compressor
115 combustion chamber
116 high-pressure turbine
117 medium-pressure turbine
118 low-pressure turbine
119 exhaust nozzle
120 guide blades
121 core engine cowling
122 compressor rotor blades
123 guide blades
124 turbine blades
125 compressor drum or compressor disc
126 turbine rotor hub
127 outlet cone

1. A gas turbine combustion chamber with an outer combustion chamber wall and an inner combustion chamber wall, wherein the outer combustion chamber wall and the inner combustion chamber wall are respectively formed in one piece with an outer or an inner ring-shaped platform which are connected in one piece with turbine inlet guide vanes that are arranged around the circumference, wherein the gas turbine combustion chamber is mounted only by means of a suspension device that is formed in one piece at the outer platform.

2. The gas turbine combustion chamber according to claim 1, wherein the outer combustion chamber wall and the inner combustion chamber wall are formed with a single wall.

3. The gas turbine combustion chamber according to claim 1, wherein the outer combustion chamber wall and the inner combustion chamber wall are formed with a double wall.

4. The gas turbine combustion chamber according to claim 1, wherein a combustion chamber head is screwed in a detachable manner to the outer combustion chamber wall and the inner combustion chamber wall.

5. The gas turbine combustion chamber according to claim 1, wherein it is formed as a full ring.

6. The gas turbine combustion chamber according to claim 1, wherein it is formed from individual segments.

7. The gas turbine combustion chamber according to claim 1, wherein the number of turbine inlet guide vanes is an integral multiple of the number of fuel nozzles.

8. The gas turbine combustion chamber according to claim 1, wherein it is made of CM247, CM247LC, MarM002 or Hastelloy X.

9. A method for manufacturing a gas turbine combustion chamber according to claim 1, in which the gas turbine combustion chamber is manufactured by means of an additive method.

10. The method according to claim 9, wherein the additive method is a DLD method or a DLMS method.
